(19) United States
(12) Patent Application Publication
(10) Pub. No.: US 2009/0163679 A1
(43) Pub. Date: Jun. 25, 2009

(54) Suspension polymerization process for manufacturing ultra high molecular weight polyethylene, a multimodal ultra high molecular weight polyethylene homopolymeric or copolymeric composition, a ultra high molecular weight polyethylene, and their uses

(75) Inventors: Alan Kardec Do Nascimento, Salvador (BR); Etienne Marcos De Almeida Rocha, Salvador (BR); Giancarlo Santana Roxo, Salvador (BR)

Correspondence Address: BIRCH STEWART KOLASCH & BIRCH, PO BOX 747, FALLS CHURCH, VA, 22040-0747, US

(73) Assignee: BRASKEM S.A., Camacari - Ba (BR)

(21) Appl. No.: 12/003,049

(22) Filed: Dec. 19, 2007

(51) Int. Cl. C08F 110/02; C08F 2/00

(52) U.S. Cl. 526/65; 526/352

(57) ABSTRACT

The present invention relates to a suspension polymerization process for the production of ultra high molecular weight polyethylene, wherein the operation is carried out in at least two reactors of the CSTR type (continuous stirring tank reactor), in a serial configuration, wherein the first reactor is fed with solvent, monomer and, optionally, comonomer; Ziegler-Natta type catalyst, said catalyst composition having a chloride concentration of at least 55%, based on its composition, and preferably more than 76%, chlorinated cocatalyst and chain growth regulator, said continuous stirring tank reactor being kept under a pressure between 0.1 to 2.0 MPa and temperature from 40° C. to 100° C., which contents of the first reactor are transferred to the subsequent reactor, by means of a pressure differential or through pumping, wherein said subsequent reactors are kept under a pressure between 0.1 to 2.0 MPa and temperature from 40° C. to 100° C., and fed with solvent, monomer, and, optionally, comonomer, catalyst, cocatalyst and chain growth regulator, the pressure and temperature in each of the reactors being different from one another up to the “n^{th}” reactor, the number of reactors “n” varying from 2 to 4; the suspension thus obtained in reactor “n” being centrifugated for the removal of solvent and dried in a fluidized bed drier; thereby resulting in an ultra high molecular weight polyethylene homopolymeric or copolymeric composition with polydispersity greater than or equal to 6.

### INTRODUCTION

The present invention relates to the preparation of ultra high molecular weight olefinic homopolymers and copolymers, particularly ultra high molecular weight polyethylene (UHMWPE), with a multimodal molecular weight distribution, which copolymers may contain up to 5 mol % of an alpha-olefin comonomer containing from 3 to 10 carbon atoms. The polymer, which is object of the present invention, is especially suitable for the production of synthetic UHMWPE yarns, via gel spinning process.

The world market for synthetic yarns has been growing up at robust rates in excess of 20% per year. Nonetheless, the UHMWPE yarn market has met very definite growing limitations not only in terms of a result of production technology concentration, basically the privilege of only one yarn manufacturer, but also because this yarn manufacturer has limited raw material availability. Another limiting factor, curbing this market growth of yarns, is the lack of initiatives regarding cost reduction of synthetic yarn production, as well as yarn property improvements, which would greatly allow for the spread of their uses and applications.

Technological development and the need for ever more efficient and lower cost processes force the market to demand more and more superior performance materials. In the case of armored vehicles, for either civil or military uses, characteristics such as better relation between performance and weight, which in turn results in lighter parts and equipment, are very important requirements when one considers the ease of moving the vehicles and the fuel savings data. In the case of high performance yarns and cables, such as those employed, for example, in safely holding the oil producing offshore rigs, known as mooring cables, the weight of the cable itself can be responsible for the cable failure, due to its length. The fact that the specific weight of the cable is lower than that of water itself is also an advantage when one takes into account the installation savings and material losses reduction.

Ultra high molecular weight polyethylenes with multimodal molecular weight distributions (MWD) show very definite advantages during processing, as compared with those currently existing monomodal distribution ones. Their self-lubrication characteristic, resulting from the low molecular weight molecules present in the polymeric material, facilitates the flow of the higher molecular weight polymeric molecules and reduces processing equipment energy consumption. In the case of the ultra high molecular weight polyethylene used in the synthetic yarns manufacturing process via a gel spinning technology, or simply gel spinning, multimodal molecular weight distribution polymers provide not only higher productivity of equipment, but better yarn properties as well, since that self-lubricating characteristic avoids polymer degradation.

This behavior has been made evident in the investigation of multimodal yarn manufacturing processes disclosed in two Brazilian patent applications, numbers PI 0702310-3 and PI 0702313-8, both assigned to the present applicant, in which processes the yarns obtained from bimodal MWD polymers exhibit better properties as compared to those obtained from monomodal MWD ones. These so-called bimodal and multimodal yarns allow for the production of ropes, cables, fishing parts, parachutes, armored panels, special helmets, bullet proof vests and hose reinforcement of excellent quality, by means of their outstanding properties, such as high wear resistance, specific weight lower than 1.0 g/cm³, high chemical resistance, extremely high tenacity—50% higher than yarns or fibers made from aramid polymers. Blends of such yarns are also mandatory components in the manufacture of reinforced parts where high impact resistance is desired.

Commercial yarns manufactured from UHMWPE characteristically show the following main properties: (i) tenacity in excess of 10 cN/denier, (ii) less than 6% elongation, (iii) low creep (longitudinal deformation under flowing conditions), and (iv) density lower than 1.0 g/cm³. These characteristics can be achieved using either monomodal or multimodal MWD UHMWPE. However, certain polymers with multimodal MWD, or rather those that show special molecular weight compositions, as it will be described herein later on, allow for the manufacture of yarns with these properties, or better than, in a more competitive means, not only in terms of physical properties, but also in terms of industrial plant processability, and in terms of economical and environmental standpoints, as well, if compared to polymer compositions currently described in the art.

### FIELD OF THE INVENTION

The present invention provides a suspension polymerization process for producing polyolefins, more specifically, polyethylene, in two or more reactors in series, using a Ziegler-Natta type catalytic system, capable of producing polymers with multimodal molecular weight distribution, whose utilization in gel spinning processes yields definite advantages as compared to those with monomodal molecular weight distributions.

Standard technologies for the manufacture of polymer yarns in gel spinning processes pose a productivity limitation, in that the monomodal polymer undergoes molecular chains degradation whenever extruding conditions are close to critical limits, for example high shear rates applied to the polymer both in the screw and spin block. Nonetheless, these high shear conditions are necessary to guarantee the proper alignment of the polymer molecular chains, which leads to better yarn mechanical properties. The present invention attempts to solve this problem, proposing the use of polymers with multimodal molecular weight distributions in gel spinning processes, since the portions of low molecular weight polymer chains which are present in the multimodal material facilitate the flow of the higher molecular weight polymeric molecules, thus reducing the degradation via breakdown of said polymer chains. Besides, the use of multimodal polymer, as obtained in the process of the present invention, reduces extruder energy consumption by as much as 20%. Summarizing, there are at least two very definite advantages in the utilization of the new homopolymer or copolymer compositions of the present invention, herein also called new polymers: the reduction of costs and the improvement of the productivity without any loss whatsoever in the properties of the final product thus manufactured.

Multimodality can be expressed as a function of the polymer polydispersity. The polydispersity of a polymer is the measure of the degree of its molecular weight distribution. Polydispersity is defined as the ratio between its weight-average molecular weight (Mw) and its number-average molecular weight (Mn). The higher the polydispersity, the wider the molecular weight distribution is.

Polyolefins with a high polydispersity are products having a noteworthy commercial value, due to the fact that they are products that couple good processability, provided by their lower molecular weight fractions, with excellent mechanical properties coming from their higher molecular weight fractions.

Polymerization processes that aim to manufacture low molecular weight multimodal polymers or copolymers, that is, with a molecular weight of less than 1,000,000 g/mol, are well known to the art and are particularly interesting from an industrial standpoint. Such processes are generally carried out by means of mixing various catalytic systems in the same reactor, or else using the same catalytic system in multi-stage reactors.

Notwithstanding, the production of multimodal ultra high molecular weight polyolefin copolymers or homopolymers entails much greater complexity, therefore feasible processes for the production of such multimodal materials are not available in the art.

Molecular weight distribution is a particularly interesting property, in the case of ethylene polymers and copolymers, since it directly affects their rheological behavior and, consequently, the polymer processability, besides final properties. Polyolefins with wider molecular weight distributions are preferred, for instance, in gel spinning processes, in which narrow molecular weight distribution polymers tend to cause processability problems due to turbulent flow.

The use of bimodal or multimodal molecular weight distribution polymers, preferably selected from reactor-bimodal or reactor-multimodal homopolymers or copolymers, will make it easier processing the gel, during the production of yarns in a gel spinning process. This renders it possible to operate at higher polymer gel concentrations, therefore obtaining a higher industrial productivity.

There are no available multimodal ultra high molecular weight polymer compositions, coming from a controlled polymerization reaction system, with the required multimodal characteristics for gel spinning processes. At the same time, there are no descriptions of processes for obtaining such material in the art. Therefore, there is a need to develop a controlled polymerization process for the production of ultra high molecular weight polyethylene with a multimodal molecular weight distribution, so as to optimally fulfill the requirements of gel spinning processes.

### BACKGROUND OF THE INVENTION

The present invention relates to the preparation of ethylene homopolymers and copolymers, particularly ultra high molecular weight polyethylene (UHMWPE), with a multimodal molecular weight distribution, which copolymers may contain up to 5 mol % of an alpha-olefin comonomer having 3 to 10 carbon atoms.

The polymerization process of the present invention takes place by means of a catalytic system comprising the product of the reaction between an aluminum-alkyl compound and a solid catalytic component comprising magnesium halide supported titanium compound, having very particular surface characteristics.

According to the process of the present invention, ethylene copolymers or homopolymers can be manufactured comprising up to 5 mol % of ethylene derived units, which are characterized by a multimodal molecular weight distribution, preferably a bimodal molecular weight distribution, and a large polydispersity, as measured by Gel Permeation Chromatography (GPC).

The large polydispersity is achieved through controlled polymerization in multiple stages, based on the production of different sized polymeric fractions in simple stages, sequentially forming macromolecules of different sizes.

According to the objectives of the present invention, the control of molecular weight to be produced at each stage can be achieved through different methods, such as, varying the polymerization conditions or the catalytic system in each stager or using a molecular weight regulator. Besides those, molecular weight control can also be obtained by controlling reaction temperature, by the selection of the aluminum-alkyl compound or the amount of hydrogen present, being the process carried out in both gaseous phase systems or liquid suspension reaction systems.

There are a number of disclosures of low molecular weight polyolefins production processes in the art, that is, polyolefins having molecular weights of less than 2,000,000 g/mol, with a wide molecular weight distribution, produced in a single reactor, using two distinct and separated catalytic systems, wherein each catalyst produces polyolefins with different molecular weights and molecular weight distributions. It just happens that such processes are not suitable for the production of ultra high molecular weight polyolefins for various reasons.

Brazilian patent PI 8203591, filed in 1982, by Diedrich et al., claims the production of a catalytic system composed of two distinct components, the components being sequentially manufactured and fed into a single reactor. The use of such a system allows for the production of a polymer with a wide molecular weight distribution, and molecular weights between 30,000 g/mol and 2,000,000 g/mol.

In patent U.S. Pat. No. 6,462,149 B1, from 2002, Tilston et al. review many patents using catalytic mixtures with different productivity catalytic sites, so as to produce bimodal polymers in a single reactor, corresponding to intrinsic viscosities (IV) lower than 5 dl/g and molecular weights of less than 300,000 g/mol.

Patent EP 0,601,524 A1, from 1993, discloses a process carried out in one or two gas phase reactors, with a spherical titanium catalyst supported in magnesium halide having at least one titanium-halogen bond, and an alkyl compound. Products originated from such a system show a melt flow index ranging from 0.12 to 0.565 g/10 min, corresponding to a molecular weight from about 100,000 g/mol to 500,000 g/mol.

In patent EP 1,337,565 B1, from 2007, Mink et al. describe the production of a bimodal polymer made in a reactor by means of a new metallocenic bimetallic catalyst. The melt flow index range of such products is between 4.5 and 130 g/10 min, corresponding to a molecular weight from 5,000 g/mol to 200,000 g/mol.

None of the processes described above would be suitable, let alone feasible, for the production of multimodal ultra high molecular weight polymers, that is, polymers having molecular weight above 2,000,000 g/mol, such as the objective of the present invention.

The main disadvantage of the current processes for the production of wide molecular weight distribution polymers in a single reactor, such as those described above, is that the amount and the productivity of the two catalysts used for controlling the low and high molecular weight fractions are hard to control, and generally lead to non-homogeneous materials, including particle size aspects, which in turn leads to a possible segregation of the materials, and consequently to variations in final properties. There have been proposed many solutions to overcome such problems, such as the one disclosed in patent U.S. Pat. No. 6,462,149 B1, from 2002, already mentioned above, in which two catalytic systems of different reactivities are mixed in different proportions, each one of these mixtures being injected in the reactor at different proportions. However, these attempts have not yet been completely satisfactory due to the lack of homogeneity of the final polymer thus obtained.

Similarly to the processes for the production of bimodal polymers in a single reactor, there are descriptions, but less in number, of processes for the production of medium molecular weight polyolefins, up to 1,000,000 g/mol, with bi- or multimodal molecular weight distribution, in multiple reactors, as listed in the art. In most of these processes, it is normally used a single catalyst, in two or more reactors. The control of the molecular weight and molecular weight distribution obtained in each stage of these reactors is generally achieved by varying polymerization conditions, or the catalytic system, comprising the catalyst and cocatalyst compounds, in each stage, and/or using a molecular weight regulator. Such processes were also not proven to be satisfactory for the industrial production of multimodal polymers with ultra high molecular weights and polymers with a suitable homogeneity of the final product.

In patent U.S. Pat. No. 4,786,697, from 1988, Cozewith et al. review various polymerization processes carried out in two reactors, as well as the production of bimodal molecular weight distribution polymers in simple pipe reactors. This patent discloses a mixture of two catalysts for the manufacture of polyolefins with bimodal molecular weight distribution in a single pipe reactor, besides describing the catalyst production process itself. The polymers so formed are copolymers with a comonomer concentration from 3 to 15 wt %. Characteristics such as polymer molecular weight of the produced polymer are not mentioned, but solely the molecular weight distribution of each mode.

Patent application EP 0,057,352 A2, from 1982, discloses a process for the production of polymers such as bimodal polyolefins, produced in a suspension process in two reactors, wherein the polymer A produced in the first reactor is a copolymer with molecular weight from 200,000 to 700,000 g/mol, and polymer B is a homopolymer with molecular weight from 10,000 to 40,000 g/mol. Viscosity ratio of A to B is from 15 to 55.

In patent EP 0,942,011 B1, from 2003, Dall'Occo at al. describe the production of a bimodal polymer in two reactors, the first being a liquid phase reactor and the second being a fluidized bed one, or loop. There is no need for employing hydrogen as a molecular weight regulator in this process. Intrinsic viscosities of the polymers as obtained in this process range from 0.5 to 6.0 dl/g, which indicates a molecular weight between 20,000 g/mol and 600,000 g/mol, the polydispersity being greater than 8.

In patent application EP 1,082,367, from 2007, Debras et al. disclose a process for the production of bimodal polymers in two reactors, wherein the monomer is ethylene, which is continuously added during the polymerization, and the comonomer is formed through the controlled oligomeryzation of ethylene, which is generated in-situ through the addition of at least one alkyl-metal cocatalyst and/or at least one alkyloxane cocatalyst, thereby affording a higher final-product polydispersity. This comonomer as obtained will copolymerize in the second reactor, thus generating bimodal copolymers. In this case, the melt flow index range disclosed is from 5 to 40 g/10 min, equivalent to a molecular weight from 50,000 g/mol to 150,000 g/mol.

Patent application US 2007/0093621 A1 also discloses a process for the preparation of bimodal polymers in two reactors, but presenting a new reactor configuration, in which the polymer circulates between the two stages. Either a Ziegler-Natta type catalyst or a metallocenic catalyst can be used. The melt flow index range indicated also is between 5 and 40 g/10 min, equivalent to a molecular weight from 50,000 g/mol to 150,000 g/mol.

However, there is not mentioned in any prior art documents above cited the production of an ultra high molecular weight polyethylene homo- or copolymer, that is, above 2,000,000 g/mol, with a bi- or multimodal molecular weight distribution.

As regards the bimodal distribution of ultra high molecular weight polymers used in gel spinning processes, there are only disclosures about the so called “false” bimodal polymers, that is, those which are the result of actual physical blending operations, outside of the polymerization reactor itself.

As an example, patent EP 1,195,355 B1, from 2003, discloses mixing two ultra high molecular weight polyethylene polymers aiming to reduce the gamma transition temperature, thereby increasing the alpha transition temperature of the yarn thus formed, allowing for an increased yarn working temperature during their application. The intrinsic viscosity of polymer A is around 18 dl/g, whereas polymer B has an intrinsic viscosity of about 28 dl/g.

Patent EP 0,320,188 B1, from 1995, discloses mixing two ultra high molecular weight polyethylenes to be used in a gel spinning process, the first one with 8.7 dl/g intrinsic viscosity, corresponding to an average molecular weight of 1,400,000 g/mol, and the second with 9.6 dl/g intrinsic viscosity, corresponding to an average molecular weight of 1,600,000 g/mol. The second polymer is a copolymer with 2.4 tertiary carbon atoms for each 1,000 carbon atoms. The polymers are dissolved in paraffinic wax with a molecular weight of 490 g/mol. The solution is spun and the yarns undergo three drawing steps. The yarns thus formed have improved creep characteristics and exhibit two endothermic peaks, wherein the peak temperatures and the differences thereof are very well defined.

Braskem S. A. and Profil Ltda. have filed two Brazilian patent applications on May 2007, reference numbers PI 0702310-3 and PI 0702313-8, disclosing a high performance yarn production process using gel spinning technology, wherein bimodal or multimodal polymers are more easily processed, affording greater polymer concentrations in the solution, thereby obtaining yarns or filaments with bimodal or multimodal molecular weight distributions. Multimodal polymer compositions may be obtained by any of the two following ways: from a two or more stages polymerization process, which is the object of the present invention, whose processing conditions lead to the so called “reactor” multimodal polymer compositions, or else from the mixture of monomodal polymers separately obtained, said blending being carried out outside the polymerization reactors themselves, which have been described in the art, whose polymer compositions are the so called “false” multimodal polymers.

The ultra high molecular weight polymer with multimodal molecular weight distribution obtained from a mixture may be obtained, in a conventional way, for instance, using reactors in a pseudoparallel set up, as depicted on FIG. 1. In such a case, processing parameters are different in the first and second reactors, resulting in polymers with different molecular weight fractions. These resulting polymers, from each reactor, are transferred to a third vessel, where the mixture of both is made, thus affording a polymer with the so called “false” multimodal molecular weight distribution.

It has not been found in the art any description about a polymerization process for the production of an ultra high molecular weight polyethylene with a multimodal molecular weight distribution suitable for the gel spinning process.

In the present invention, a controlled polymerization process was developed to obtain ultra high molecular weight polymers, above 2,000,000 g/mol average, with multimodal molecular weight distribution, prepared in multiple reactors, with a single Ziegler-Natta type catalyst, which are advantageously used in gel spinning processes. In such process, the polymerization conditions are different in each reactor, for instance, as regards cocatalyst concentration and reactant concentrations, such as molecular weight regulators, for instance hydrogen.

### OBJECTIVES OF THE PRESENT INVENTION

A better processability during polymer extrusion in the gel spinning process when using a high molecular weight polyethylene may be achieved if the molecular weight distribution of the polymer is bi- or multimodal. It is also known that a polymer composition when obtained in a reactor is more homogeneous than a composition as obtained via blending of distinct polymers. There is no commercially available, nor is it taught in the art, such a polyethylene polymeric composition with ultra high molecular weight, coming from a polymerization reaction system with those characteristics. Therefore, there is a need for the development of a polymerization process for the production of an ultra high molecular weight polyethylene with a multimodal molecular weight distribution, so that the requirements of gel spinning process can be optimally met.

Thus, the object of the present invention is to provide a combination of reactors in series, as well as processing control parameters, for the polymerization of polyolefins, more specifically ethylene, to obtain the ultra high molecular weight polyolefin, resulting in polymers with very definite molecular weights, molecular weight distribution and certain copolymerization degree. The process of the present invention is based on the use of a transition metal compound as the main catalyst, and an organo-aluminum compound as the cocatalyst, using operating configurations with two or more polymerization reactors.

Another object of the present invention is to provide a process for the production of polyolefins, especially polyethylene, resulting in materials which easily solubilize in non-polar paraffinic solvents, the resulting solution having high stability during spinning, being able of undergoing high draw ratios, and exhibiting high elasticity, tenacity, creep resistance, and low elongation values.

### BRIEF DESCRIPTION OF THE DRAWINGS

FIG. 1 is a schematic reactor layout (parallel) for obtaining bimodal or monomodal polymeric compositions, according to the prior art.

FIG. 2 is a schematic reactor layout (in series) for obtaining bimodal polymer compositions, according to the present invention.

FIG. 3 shows gel permeation chromatography of the polymer compositions as disclosed in the examples of the present invention.

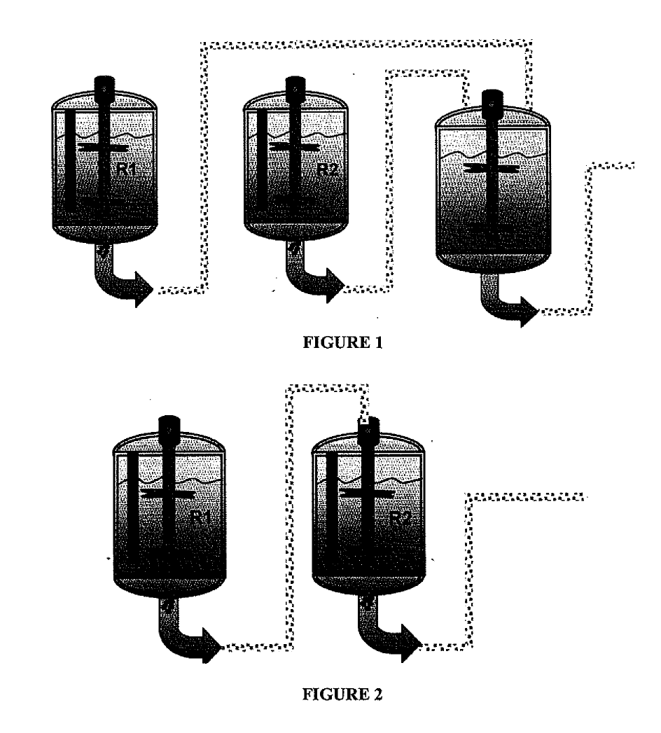

### THE PRESENT INVENTION

The present invention relates to the provision of a process for the production of a high molecular weight polyolefin, more specifically, to the polymerization of ethylene, or the co-polymerization of ethylene and another alpha-olefin, at a temperature between 40° C. and 100° C., preferably between 70° C. and 90° C., under 0.1 to 2.0 MPa pressure, preferably between 0.4 MPa and 1.2 MPa, in a hydrocarbon solvent, in the presence of a catalytic system. The catalytic system is a Ziegler-Natta type and consists of an organo-aluminum cocatalyst and a transition metal catalytic compound, which is a solid catalytic compound comprising a magnesium compound and a titanium compound.

The polymerization, which is object of the present invention, is carried out in two or more stages, with reactors configured in series, as depicted in FIG. 2. A first polymerization stage results in a polymer “A”, which is then transferred to the second reactor, where the second polymerization stage takes place. During the second stage, the second reactor is fed with the polymer obtained in the first polymerization stage, together with un-reacted monomers and comonomers, catalytic system and solvent. Additionally, a new feedstock of monomers, comonomers, catalytic system and solvent are fed to the second reactor. In the case of a polymerization process carried out in more than two stages, the resulting polymer, from the second reactor, is transferred to the third reactor in a similar way to the one described for the second reactor. This process can be repeated “n” times, “n” being greater than or equal to 2. The resulting polymer is the polymer “N”, which consists of a polymer composition, resulting from the “n” polymerization stages.

The ratios between catalyst and cocatalyst were developed in such a way that the molecular weights and the molecular weight distributions of the polymers thus formed can be controlled. Upon the reaction conditions and catalytic system disclosed in the present invention, it is possible to represent the average molecular weight as a function of cocatalyst concentration, according to the following equation:

MW(g/mol)=2.8×10⁶+35×[COCAT]

where COCAT is the cocatalyst concentration, in ppm.

This equation has been developed empirically, through various simulations and validations in pilot plant reactors, and since then such equation has been used regularly, as an operating condition basis, to obtain the desired specific molecular weights.

In table 1 below, it can be seen the influence of cocatalyst amount in the molecular weight of the polymer produced according to the present invention, keeping all other process parameters constant.

TABLE 1
Relation between cocatalyst concentration and
final polymer molecular weight, in a process described
according to the present invention

| Polymerization conditions | A | B | C | D |
|---|---|---|---|---|
| catalyst concentration/solvent (ppm) | 15 | 15 | 15 | 15 |
| cocatalyst concentration/solvent (ppm) | 20 | 40 | 60 | 80 |
| average molecular weight of final polymer | 3.5 | 4.2 | 4.9 | 5.6 |
| (×10⁶ g/mol) | | | | |

The polymerization process in two reactors may or may not occur in the presence of a chain growth regulator, such as hydrogen. Whenever hydrogen is used, the percent molar ratio of hydrogen to ethylene can vary from 0.01% to 50%.

Polymer “A” thus formed is characteristically an ethylene homopolymer or an ethylene and another alpha-olefin copolymer, and polymer “N” thus formed is also characteristically an ethylene homopolymer or an ethylene and another alpha-olefin copolymer.

Additionally, polymer “A” resulting from the polymerization reaction in the first reactor has an average intrinsic viscosity from 5 to 32 dl/g, corresponding to a molecular weight from 600,000 to 9,400,000 g/mol and, more specifically from 8 to 25 dl/g, corresponding from 1,200,000 to 6,500,000 g/mol, present at a ratio from 30 wt % to 70 wt % in the overall polymer. Average intrinsic viscosity of polymer “N” is from 10 to 55 dl/g, corresponding to an average molecular weight from 1,700,000 to 21,000,000 g/mol, and more preferably, from 12 to 40 dl/g, corresponding to an average molecular weight from 2,200,000 to 13,000,000 g/mol.

### EMBODIMENT OF THE INVENTION

### Monomer

The monomer used is, preferably, ethylene, which can be obtained from different sources, such as, from the cracking of naphtha, in turn obtained from petroleum distillation, or else from the hydrogenation of ethanol, in turn obtained from the fermentation of organic compounds, such as sugar cane.

### Comonomers

In addition to the monomer itself, there can be utilized as comonomers, in the reaction system, alpha-olefins having from 3 to 10 carbon atoms, preferably 3 to 5 carbon atoms. Comonomer concentration can reach up to 5 mol %, preferably up to 1 mol %.

### Catalytic System

A catalytic system of the Ziegler-Natta type used in the present invention is, for example, the system already disclosed in the Brazilian patent PI 9203645. Such a catalytic system consists of a catalytic component and a cocatalyst. More specifically, the Ziegler-Natta type catalyst is a titanium chloride compound supported in magnesium chloride, which has at least 55 wt % chloride. Preferably, the catalyst consists of 8 wt % to 12 wt % titanium, 8 wt % to 12 wt % magnesium, and the balance being chloride. The cocatalyst comprises an organo-aluminum compound, such as diethylaluminum chloride.

Catalyst concentrations in the “In” reactors of the present invention polymerization reaction are around 2 ppm to 20 ppm, more preferably from 10 ppm to 15 ppm, relative to the solvent mass present in the reaction mixture.

Cocatalyst concentrations, in said “n” reactors, of the polymerization process of the present invention are around 10 ppm to 100 ppm, more preferably between 20 ppm and 60 ppm, in relation to the solvent mass present in the reaction mixture.

### Chain Growth Regulator

The chain growth regulator used in the process of the present invention can be, for example, hydrogen, which can be present in all “n” reactors or not, or only in a few of those, at a molar percent ratio of chain growth regulator to olefin from 0.01% to 50%.

### Solvent

The polymerization is carried out using inert hydrocarbon solvents. These are preferably alkanes or cycloalkanes, such as iso-butane, pentane, hexane, heptane, cyclohexane, methyl-cyclohexane, or mixtures thereof. Preferably, anhydrous hexane is used, which is continuously fed into the reactors and maintained at a controlled level around 30 to 90 wt % of its capacity.

### Polymerization Conditions

Polymerization temperature in the reactors is around from 40° C. to 100° C., preferably from 70° C. to 90° C., and the reactors are kept under a pressure of 0.1 to 2.0 MPa, preferably from 0.4 MPa to 1.2 MPa. The catalytic system is continuously fed into the reactors in a controlled manner, thereby starting the polymerization reaction. Since this reaction is exothermic, a constant water flow is fed into the reactor jackets, in order to control the reaction temperature within a maximum 1° C. variation around the desired reaction temperature.

Polymer concentration, or copolymer concentration, formed in the “n” reactors, for instance, both in the first and in the second reactors, can vary from 4 wt % to 40 wt %, as compared to the total suspension weight, that is, polymer plus solvent, and is preferably in the range of from 4 wt % to 30 wt %, of the total suspension.

Total pressure in the first reactor may be higher than in the subsequent reactors, or else, total pressure in the first reactor can be lower than in subsequent reactors.

The suspension leaving the last polymerization reactor is centrifugated to separate polymer from solvent, and the polymer is dried in fluidized bed dryers using heated nitrogen in order to have the total removal of residual solvent from the polymer.

The lower molecular weight polymer fraction can be obtained both in the first or second reactor. Molecular weight control is achieved by means of a chain growth regulator, for example, through the amount of hydrogen present in the reaction mixture. Additionally, molecular weight control can also be achieved via the control of reaction temperature and/or the control of the amount of cocatalyst fed.

Multimodality is controlled by the weight ratio of the conversion to polymer in the two reactors and it is determined by the monomer weight amounts individually fed to the reactors and which are maintained within suitable ranges of said weight ratio, which is the so called “split”. The split, in a reactor in series setup, is determined as the percent weight ratio of monomers converted in the second reactor divided by the sum of the weights of monomers converted in the two reactors. In a pseudoparallel reactor configuration, as previously defined, the split is determined as the percent weight ratio of monomer converted in the reactor where the lowest molecular weight polymer was generated divided by the sum of the weights of monomers converted in the two reactors.

Molecular weight ranges were measured by means of Gel Permeation Chromatography (GPC) analyses. The GPC analytical method used for characterizing the UHMWPE is described as follows. A 0.001 g sample is dissolved in 4 ml of tri-chloro-benzene (TCB). The dissolution procedure takes one hour, under stirring, at 180° C. The solution is then injected in separation columns, without filtering, so as to avoid possible losses of ultra high molecular weight molecules. Four separation columns of the type TSK-GEL-GW-HXL-HT are used, which are manufactured by the company Waters, these columns having 7.5 mm diameter and 300 mm length. These columns are able to screen molecular weights of the order 10⁶-10⁶-10⁷-10⁷, given that the 10⁶ columns are called “mix”, because they handle separations from 10³ to 10⁶ g/mol, and the 10⁷ columns handle separations of the order 10⁷ g/mol.

At the end of the polymerization in series reactions, the polymer thus formed exhibits a multimodality which can be described by means of the molecular weight segmentation which is obtained from the GPC analysis graph. A typical polymer composition thus obtained is shown below:

MW below 500,000 g/mol—20% to 35%

MW from 500,000 to 1,200,000 g/mol—10% to 25%

MW from 1,200,000 to 3,500,000 g/mol—25% to 35%

MW from 3,500,000 to 5,500,000 g/mol—5% to 15%

MW above 5,500,000 g/mol—10% to 25%

Another inventive aspect of the present patent application is that the final polymeric composition has a weight-average ultra high molecular weight of above 2,000,000 g/mol, corresponding to an intrinsic viscosity higher than 12 dl/g.

Generally speaking, the polymeric or copolymeric composition, which is object of the present invention, has a polydispersity ranging from 6 to 15, an intrinsic viscosity from 7 to 40 dl/g, and viscosimetric molecular weights varying from 980,000 to 15,000,000 g/mol.

Another peculiarity of the polymer or copolymer compositions of the present invention is that they comprise homopolymers or copolymers with a ratio of the number of branches to 1000 carbon atoms of 0 to 10.

### USE OF THE POLYMER COMPOSITIONS OF THE PRESENT INVENTION

The multimodal ultra high molecular weight polyolefinic homopolymer or copolymer compositions of the present invention are advantageously applicable in gel spinning processes for the production of yarns and filaments, in that the gel is prepared in an extruder, with the appropriate dissolution of the homopolymers or copolymers, in an inert solvent, said gel being fed to a spin block thus forming yarns that are cooled and drawn.

The yarns comprising the multimodal ultra high molecular weight polymers or copolymers obtained from polymeric compositions of the present invention have a polydispersity in the range from 6 to 15, tenacity from 5 to 50 cN/dtex, and a creep rate lower than 4% per hour, when subjected to a load of 30% of the value of their breaking strength, at a temperature of 23° C. These yarns or filaments that form the yarn have a multimodal polymeric structure, and more preferably a bimodal structure, and they can be obtained through a gel spinning process, or else through any other filament producing process.

Such yarns and filaments, when finished up, may have a residual solvent concentration in excess of 150 ppm but lower than 500 ppm in the final yarn or filament composition.

The objective of the production of such yarns, with these characteristics and physical properties, as above cited, is the manufacture of ropes, fishing lines, hose reinforcements, diaphragms for electrolytic cells, armored panels, parachutes, tire reinforcements, and the like.

### EXAMPLES

### Examples 1 to 4 of the Present Invention

Examples 1 to 4 were conducted in a pilot plant having two reactors, both being CSTR (continuous stirring tank reactor), of 2 m³ each, having water circulation jackets both. The polymerization was carried out in a continuous phase, and process conditions are summarized in table 2. The configuration used was a reactor in series setup, which allowed production of bimodal polymers, as shown in FIG. 2. The reaction takes place in two reactors, wherein all the polymer formed in the first reactor is transferred to the second one. In these examples, the total pressure in the first reactor is greater than that in the second, and the polymer formed in the first reactor corresponds to the lower molecular weight fraction of the final polymer.

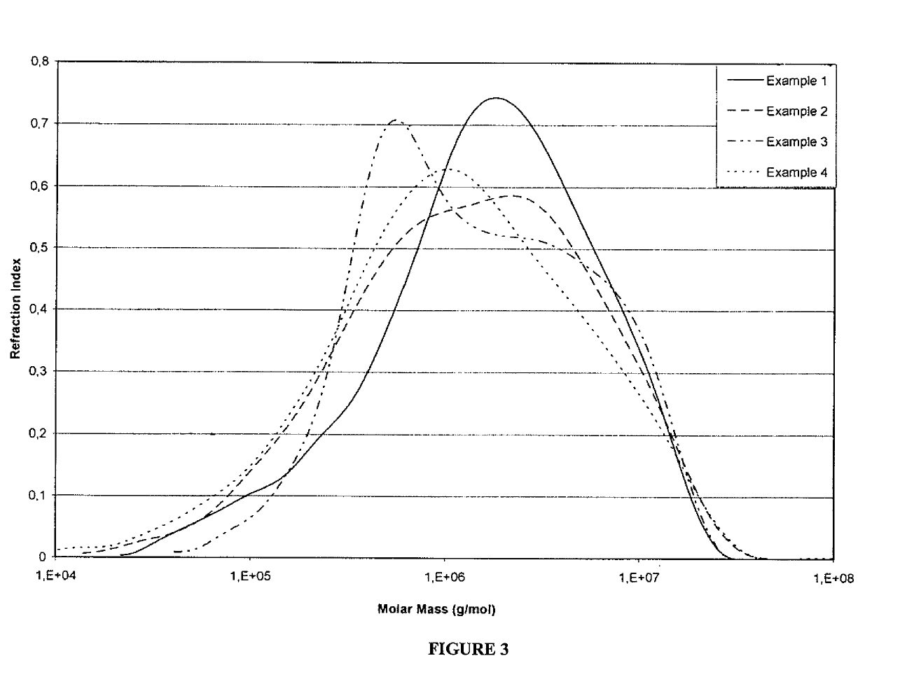

Molecular weight fractions in each of the examples 1-4 were measured using a GPC technique and the results are shown on FIG. 3. On this figure, molecular weight is shown on the x axis in g/mol, while refraction index is on the Y axis. The values corresponding to some of the molecular weight fractions are also shown in table 2.

TABLE 2
Reaction conditions and properties of polymers obtained

| | Example 1 | | Example 2 | | Example 3 | | Example 4 | |
|---|---|---|---|---|---|---|---|---|
| | REACTOR | | | | | | | |
| | 1 | 2 | 1 | 2 | 1 | 2 | 1 | 2 |
| Reactor conditions | | | | | | | | |
| ethylene feed (kg/h) | 36.2 | 34.0 | 31.6 | 31.2 | 29.7 | 30.3 | 57.0 | 58.0 |
| polymer concentration (kg/kg) | 4.7 | 5.3 | 4.2 | 4.9 | 4.1 | 5.6 | 8.5 | 11.1 |
| total reactor pressure (×10⁻¹ MPa) | 4.9 | 3.3 | 6.7 | 5.4 | 6.7 | 5.3 | 5.3 | 2.9 |
| reactor temperature (° C.) | 79 | 62 | 79 | 60 | 83 | 72 | 82 | 80 |
| catalytic activity | 3.5 | 6.8 | 1.9 | 3.5 | 1.8 | 3.1 | 3.3 | 7.4 |
| (gₚₒₗ/[g_{cat} * h * 0.1 MPa]) | | | | | | | | |
| catalyst concentration (ppm) | 3.1 | 1.8 | 3.1 | 1.8 | 3.5 | 2.4 | 6.0 | 4.0 |
| cocatalyst concentration (ppm) | 50.9 | 61.2 | 46.4 | 57.8 | 34.9 | 63.3 | 25.0 | 30.0 |
| cocatalyst to catalyst ratio | 16.5 | 33.9 | 15.2 | 32.5 | 10.0 | 26.5 | 4.2 | 7.5 |
| catalytic yield (gₚₒₗ/g_{cat}) | 16.2 | 15.1 | 14.5 | 14.4 | 12.3 | 12.6 | 15.1 | 15.2 |
| molar ratio of H₂ to monomer in | 4.5 | 3.3 | 0.7 | 0 | 0 | 0 | 14.8 | 0.9 |
| vapor phase | | | | | | | | |
| molar ratio of comonomer to | 0 | 0 | 0 | 0 | 0 | 0 | 7.6 | 1.5 |
| monomer in vapor phase | | | | | | | | |

| | | | | |
|---|---|---|---|---|
| Split (%) | 48.6 | 49.7 | 50.5 | 50.0 |
| Polymer Properties | | | | |
| viscosimetric-molecular weight | 4.4 | 5.9 | 7.1 | 2.3 |
| (×10⁶ g/mol) | | | | |
| intrinsic viscosity (dl/g) | 19.2 | 23.5 | 26.5 | 13.5 |
| weight-average molecular weight | 3.2 | 3.4 | 3.1 | 2.9 |
| (Mw, ×10⁶ g/mol) | | | | |
| Polymer Composition (% g/mol) | | | | |
| MW fraction < 0.5 × 10⁶ | 20 | 24 | 28 | 33 |
| 0.5 × 10⁶ < MW fraction < 1.2 × 10⁶ | 21 | 18 | 14 | 17 |
| 1.2 × 10⁶ < MW fraction < 3.5 × 10⁶ | 32 | 29 | 25 | 27 |
| 3.5 × 10⁶ < MW fraction < 5.5 × 10⁶ | 9 | 11 | 10 | 10 |
| MW fraction > 5.5 × 10⁶ | 18 | 18 | 23 | 13 |
| Polydispersity | 5.2 | 7.6 | 4.7 | 8.6 |
| average particle size (μm) | 169 | 168 | 177 | 200 |
| bulk density (g/cm³) | 0.40 | 0.41 | 0.39 | 0.38 |

### Example 5 of the Present Invention

In this example, the purpose was to produce an ultra high molecular weight polyethylene, operating the first reactor at a total pressure lower than that of the second reactor, and the polymer thus formed in the first reactor corresponds to the higher molecular weight fraction of the final polymer. The hydrogen to ethylene ratios in the first and second reactors were in the ranges of 0.4-0.5% and 8-10%, respectively. The pressure in the first reactor was kept within 0.9-1.1 MPa, and in the second reactor, within 1.1-1.2 MPa. The weight-average molecular weight was 2.5×10⁶ g/mol and the polydispersity was 9.

### Comparative Examples 1 and 2

The comparative examples that follow have aimed to compare the performance in a gel spinning process of the UHMWPE with a bimodal molecular weight distributions, according to the present invention, with UHMWPE with a monomodal molecular weight distribution as well as with a low molecular weight polyethylene with a bimodal molecular weight distribution, both last ones described in the art.

Comparative example 1 relates to a polyethylene having low molecular weight and bimodal-reactor molecular weight distribution. The process for obtaining this polymer is already disclosed in the art, for example, in Brazilian patent PI 8200617. The objective of the comparison between this polymer and those obtained in examples 1-5 is to evaluate the influence of the molecular weight on the performance of a polymer, in a gel spinning process, the polymer having a similar polydispersity range.

Comparative example 2 relates to a polyethylene having ultra high molecular weight and monomodal molecular weight distribution. The process for obtaining such a polymer is already disclosed in the art, for example, in Brazilian patent application PI 9203645-7A. The objective of the comparison between this polymer and those obtained in examples 1-5 is to evaluate the influence of the molecular weight distribution on the performance of the polymer, in a gel spinning process, said polymer having a similar molecular weight range.

The properties of the polymers referred to, in the comparative examples above, are shown in table 3.

TABLE 3
Reaction conditions and properties of the polymer thus formed -
comparative examples

| | | comparative |
|---|---|---|
| Polymer properties | comparative ex. 1 | ex. 2 |
| Viscosimetric-molecular weight | below 0.5 | 3.4 |
| (×10⁶ g/mol) | | |
| intrinsic viscosity (dl/g) | below 5.0 | 16.2 |
| weight-average molecular weight | 0.12 | 3.0 |
| (Mw, ×10⁶ g/mol) | | |

Polymer Composition (% g/mol)

| | | |
|---|---|---|
| MW fraction < 0.5 × 10⁶ | 100 | 19 |
| 0.5 × 10⁶ < MW fraction < 1.2 × 10⁶ | 0 | 25 |
| 1.2 × 10⁶ < MW fraction < 3.5 × 10⁶ | 0 | 29 |
| 3.5 × 10⁶ < MW fraction < 5.5 × 10⁶ | 0 | 11 |
| MW fraction > 5.5 × 10⁶ | 0 | 16 |
| Polydispersity | 7.4 | 3.9 |
| Average particle size (μm) | 290 | 180 |
| bulk density (g/cm³) | 0.46 | 0.40 |

Each one of the polymers described in examples 1-5, and in the comparative examples 1-2, was used as a raw material for the preparation of a gel, which was later processed in a gel spinning process. The conditions of the extrusion process, in which gel spinning took place, were the following: (i) 12 wt % polymer concentration; (ii) mineral oil used as gelling agent; (iii) 36 rpm extruder screw speed; (iv) take-up spool speed of 9 m/min; (v) extrusion zone temperatures: 270° C.-280° C.-290° C.; (vi) temperature of the extruded beam of 290° C.; (vii) extruder length to diameter ratio (L/D) of 33; (viii) spinneret dimensions: 20 holes, 0.5 mm diameter and 15 mm length, 30 L/D. The extrusion step was carried out in the presence of oxygen. The resulting yarns were washed and drawn in multiple stages.

Various spinning process parameters were evaluated for each of the runs made, such as pressure immediately upstream of the spinneret, stability of the just-formed yarns, filament breaks ratio during the drawing step, and final draw ratio. These parameters can be seen in table 4.

TABLE 4
Performance of the polymers described in the present invention in a
gel spinning process

| | spinneret | | Filament | maximum |
|---|---|---|---|---|
| | pressure | filament | breaks | draw |
| Example | (MPa) | stability | ratio | ratio |
| Example 1 | 3.5 | good | low | 18.9 |
| Example 2 | 4.0 | excellent | very low | 18.5 |
| Example 3 | 4.0 | good | low | 18.5 |
| Example 4 | 4.0 | very good | low | 18.5 |
| Example 5 | 3.5 | very good | very low | 16.5 |
| Comparative example 1 | 1.0 | bad | very high | * |
| Comparative example 2 | 4.0 | regular | average | 17.2 |

* It was not possible to obtain yarns able to undergo the drawing step.

According to the results shown in table 4 above, one can unexpectedly and surprisingly note that multimodal ultra high molecular weight polymers or polymer compositions, such as the one obtained according to the process of the present invention, are able to promote better processability on industrial gel spinning type equipment, such as those used for yarn production through gel spinning and drawing processes, providing yarns with better stability and lower break ratios when compared to those polymer materials, already mentioned in the art, used in gel spinning processes.

1. A suspension polymerization process for manufacturing ultra high molecular weight polyethylene, wherein the operation is carried out in at least two reactors of the CSTR type (continuous stirring tank reactor), in a serial configuration, wherein the first reactor is fed with solvent, monomer, and, optionally, comonomer; Ziegler-Natta type catalyst, said catalyst composition having a chloride concentration of at least 55%, based on its composition, chlorinated cocatalyst, and chain growth regulator, said continuous stirring tank reactor being kept under a pressure between 0.1 to 2.0 MPa and temperature from 40° C. to 100° C., and which contents of the first reactor are transferred to the subsequent reactor by means of a pressure differential or through pumping, wherein said subsequent reactors are kept under a pressure between 0.1 to 2.0 MPa and temperature from 40° C. to 100° C., and fed with solvent, monomer and, optionally, comonomer, catalyst, cocatalyst and chain growth regulator, the pressure and temperature in each of the reactors being different from one another up to the “n^{th}” reactor, “n” varying from 2 to 4; the suspension thus obtained in reactor “n” being centrifugated for the removal of solvent and dried in a fluidized bed drier; thereby resulting in a polyethylene homopolymer or copolymer composition having ultra high molecular weight, with polydispersity greater than or equal to 6.

2. Process according to claim 1, wherein said monomer is preferably ethylene.

3. Process according to claim 1, wherein said comonomer is an alpha-olefin having from 3 to 10 carbon atoms.

4. Process according to claim 3, wherein said comonomer preferably is an alpha-olefin having from 3 to 5 carbon atoms.

5. Process according to claim 1, wherein said solvent is an inert hydrocarbon.

6. Process according to claim 5, wherein said solvent is preferably an alkane or a cycloalkane.

7. Process according to claim 1, wherein said solvent is selected from the group comprising iso-butane, pentane, hexane, heptane, cyclohexane, methyl-cyclohexane, or mixtures thereof.

8. Process according to claim 7, wherein said solvent preferably is anhydrous hexane.

9. Process according to claim 1, wherein said solvent is continuously added to the reactors and kept at a controlled level from 30 to 90% of its capacity.

10. Process according claim 1, wherein the concentration of the polymer or copolymer thus formed in any of the “n” reactors may vary from 4 wt % to 40 wt %, relative to the total suspension weight.

11. Process according to claim 10, wherein the concentration of the polymer or copolymer thus formed in any of the “n” reactors preferably is from 4 wt % to 30 wt %, relative to the total suspension weight.

12. Process according claim 1, wherein the copolymer of said copolymeric composition can have up to 5 mol % of a comonomer, comprising an alpha-olefin having from 3 to 10 carbon atoms.

13. Process according to claim 1, wherein the catalyst concentrations in any of said “n” reactors range from 2 ppm to 20 ppm, relative to the solvent mass in the reaction mixture.

14. Process according to claim 13, wherein the catalyst concentrations in any of said “n” reactors preferably range from 10 ppm to 15 ppm, relative to the solvent mass in the reaction mixture.

15. Process according to claim 1, wherein cocatalyst concentrations in any of said “n” reactors range from 10 ppm to 100 ppm, relative to the solvent mass present in the reaction mixture.

16. Process according to claim 15, wherein said cocatalyst concentrations in any of said “n” reactors range from 20 ppm to 60 ppm, relative to the solvent mass present in the reaction mixture.

17. Process according to claim 1, wherein said Ziegler-Natta type catalyst comprises magnesium chloride supported titanium chloride, preferably with 8 wt % to 12 wt % titanium and 8 wt % to 12 wt % magnesium in its composition, the balance being chloride.

18. Process according to claim 1, wherein said chlorinated cocatalyst is di-ethyl-aluminum chloride.

19. Process according to claim 1, wherein said chain growth regulator is hydrogen used at percent mole ratio of hydrogen to olefin from 0.01% to 50%.

20. Process according to claim 1, wherein the total pressure in the first reactor is higher than that of the subsequent reactors.

21. Process according to claim 1, wherein the total pressure in the first reactor is lower than that of the subsequent reactors.

22. Process according to claim 1, wherein the pressure in the reactors is preferably in the range from 0.4 MPa to 1.2 MPa.

23. Process according to claim 1, wherein the temperature in the reactors is preferably in the range of 70° C. to 90° C.

24. Multimodal ultra high molecular weight polyethylene homopolymeric or copolymeric composition, wherein it is obtained from the process defined in claim 1.

25. Ultra high molecular weight polyethylene homopolymeric or copolymeric composition obtained from the process according to claim 1, wherein the lowest molecular weight polymer fraction is obtained in the first reactor.

26. Ultra high molecular weight polyethylene homopolymeric or copolymeric composition obtained from the process according to claim 1, wherein the lowest molecular weight polymer fraction is obtained in the second or subsequent reactors.

27. Ultra high molecular weight polyethylene homopolymeric or copolymeric composition according to claim 25, wherein the molecular weight distribution is multimodal.

28. Composition according to claim 27, wherein said multimodal molecular weight distribution is preferably bimodal.

29. Homopolymeric or copolymeric composition as obtained by the process according to claim 1, wherein the polydispersity is from 6 to 15, the intrinsic viscosity is from 7 to 40 dl/g and the viscosimetric molecular weight is from 980,000 to 15,000,000 g/mol.

30. Composition according to claim 24, wherein it has the following molecular weight segmentation: molecular weight lower than 500,000 g/mol—between 20% and 35%, preferably between 20% and 30%; molecular weight from 500,000 to 1,200,000 g/mol—between 10% and 25%, preferably between 15% and 20%; molecular weight from 1,200,000 to 3,500,000 g/mol—between 25% and 35%, preferably between 25% and 30%; molecular weight from 3,500,000 to 5,500,000 g/mol—between 5% and 15%, preferably between 10% and 15%; molecular weight higher than 5,500,000 g/mol—between 10% and 25%, preferably between 15% and 25%; the percentages being expressed based on the total weight of the composition.

31. Composition according to claim 25, wherein the homopolymer or copolymer thus formed has a ratio of branches to 1,000 carbons ranging from 0 to 10.

32. Multimodal ultra high molecular weight polyethylene wherein it is obtained from the polymerization process defined in claim 1, and wherein the polydispersity ranges form 6 to 15, the intrinsic viscosity ranges from 7 to 40 dl/g, and the weight-average molecular weight (Mw) is higher than 2,000,000 g/mol.

33. Use of the ultra high molecular weight polyethylene homopolymeric or copolymeric composition as defined according to claim 25, wherein it is in a gel spinning process for the production of multimodal filaments.

34. Use of the ultra high molecular weight polyethylene homopolymeric or copolymeric composition as defined according to claim 25, wherein it is for the production of filaments with polydispersity ranging from 6 to 15, tenacity ranging from 5 to 50 cN/dtex, and having a creep rate lower than 4% per hour, when subjected to a load of 30% of its breaking strength, at a temperature of 23° C.

35. Use of the ultra high molecular weight polyethylene homopolymeric or copolymeric composition as defined according to claim 25, wherein it is for manufacturing yarns suitable to make ropes, fishing lines, hose reinforcements, diaphragms for electrolytic cells, armored panels, parachutes, tire reinforcements and the like.

36. Use of the ultra high molecular weight polyethylene homopolymeric or copolymeric composition as defined according to claim 25, wherein it is for the manufacture of yarns which may have a final residual solvent concentration higher than 150 ppm and lower than 500 ppm in the final yarns composition.

37. Use of the ultra high molecular weight polyethylene homopolymeric or copolymeric composition obtained according to claim 25, wherein it is for the manufacture of yarns or filaments which have bimodality or multimodality, obtained by means of a gel spinning process or any other filament production processes.
